(19) United States
(12) Patent Application Publication
(10) Pub. No.: US 2015/0297985 A1
(43) Pub. Date: Oct. 22, 2015

(54) PROCESS FOR TRANSFERRING AND UTILIZATION OF GOLF COURSE IMAGES FOR GOLF SIMULATION SYSTEMS

(71) Applicant: Larry Henry, Novi, MI (US)

(72) Inventor: Larry Henry, Novi, MI (US)

(21) Appl. No.: 14/256,985

(22) Filed: Apr. 20, 2014

(51) Int. Cl. A63F 13/00

(52) U.S. Cl. CPC A63F 13/005; A63F 2300/8011

(57) ABSTRACT

This invention will enable anyone to take golf course pictures with a cell phone or digital camera, download them instantly for play on a golf simulation device, creating potentially thousands of virtual golf courses. The training method embodied in this invention will enable a golfer to play their simulated local golf course in as little as six to twelve minutes, with a visualization technique commonly used by professional golfers. This invention will create virtual golf courses for a fraction of the current cost, give golfers a reason to use simulators all year and help a struggling industry, while drawing more business to outdoor courses as golfers test their simulator training on the actual courses outside.

### CROSS-REFERENCE TO RELATED APPLICATIONS

This application refers to and claims the benefit of the filing date of Provisional Patent Application U.S. 61/814,221

### STATEMENT REGARDING FEDERALLY SPONSORED RESEARCH OR DEVELOPMENT

Not Applicable

### DIGITAL OR MICROFICHE APPENDIX

Not Applicable

### BACKGROUND OF THE INVENTION

1. Field of the Invention

This invention relates to the golf industry. In particular it relates to golf simulation systems which can track shots and display the results with computer programming to generate simulated golf courses, so that golfers feel as if they are playing outside. More particularly, this invention relates to a combination of how golf course images are transferred and utilized by golf simulation systems.

2. Description of the Related Art

Most golf simulation devices are capable of tracking golf shots and displaying the results as if the ball were traveling on the actual golf course. In order to achieve a realistic experience, extensive programming is required, thus limiting the number of golf courses available for play. Currently only the manufactures of golf simulators can choose and create golf courses for their machines and these course are expensive to develop, the cost of which is passed on to the consumer. Golf simulators are used primarily during the winter months as people prefer to play outside when weather permits which results in a high failure rate with commercial golf simulator applications. This invention addresses the limited course availability, cost of programming and seasonal effect on sales in the golf simulation industry.

### SUMMARY OF THE INVENTION

This invention makes it possible for anyone to take golf course photos with a cell phone or camera and upload the image(s) instantly for play on golf simulators, world-wide. This invention will enable anyone to add their local golf course for play on a simulator for home, or commercial center and play a round of golf in as little as six to twelve minutes. This invention embodies a visualization technique that will enable an average golfer to train like a tour player does before they compete in a professional tournament. This invention will make it possible to create thousands of local public golf courses for play on simulators, where only a limited number of famous courses currently available.

### BRIEF DESCRIPTION OF DRAWINGS

FIG. 1 is an overview of the process for transferring images and software to a golf simulator using a cell phone.

FIG. 2 is an overview of the process for transferring images and software to a golf simulator using a digital or video camera.

FIG. 3 shows an example of locations for taking photos on each of the three types of golf holes, par 3, par 4 and par 5.

FIG. 4 shows three extreme club head paths of a golf swing, and their resulting ball trajectory

### REFERENCE NUMERALS IN THE DRAWINGS

1 View of a complete golf hole
2 Cell phone (Internet enabled)
3 Partial image of golf hole shown in item #1
4 Wireless Internet
5 Website/Internet servers
6 Golf simulation device
7 Digital camera
8 Personal Computer
9 Top view of par 3 golf hole
10 Top view of par 4 golf hole
11 Top view of par 5 golf hole
12 Location where the first photo is taken when playing a complete hole or series of holes.
13 Location where the second photo is taken when playing a par 4 or par 5.
14 Location where third photo is taken when playing a par 5.
15 Example of a hooked golf shot (right hand golfer).
16 Example of a straight golf shot (right hand golfer).
17 Example of a slice golf shot (right hand golfer)

### DETAILED DESCRIPTION OF INVENTION

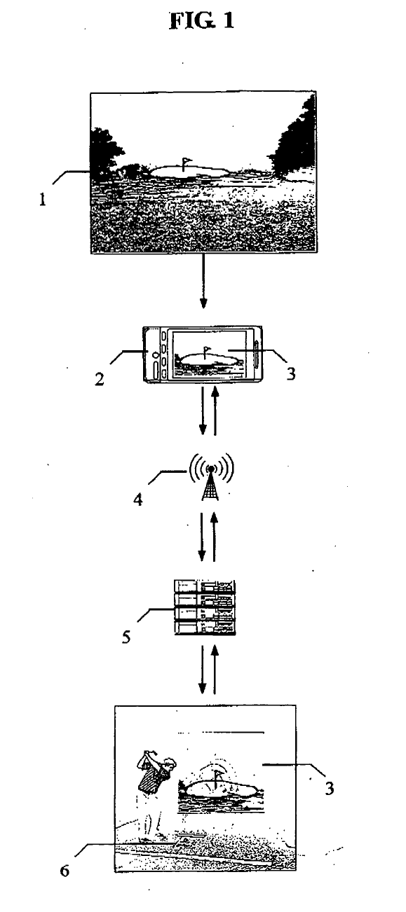

Referring now to the invention in more detail, in FIG. 1—This drawing shows the process of how a photographic image is taken using a cell phone and then transferred to a golf simulator through the internet, using wireless technology.

Drawing #1 is a view of an entire golf hole.

Drawing #2 is a cell phone which has captured a picture of a personally selected portion of the golf hole displayed in drawing #1.

Drawing #3, is the image captured by the cell phone displayed in drawing #2

Drawing #4 symbolizes the wireless Internet through which the cell phone transfers the image to the website servers.

Drawing #5 is a bank of Internet servers which house the website that will receive the image and make it available for final transfer to a simulator.

Drawing #6 is an example of a golf simulator with the personally selected portion of a golf hole displayed (#3), and golfer with a swing in process.

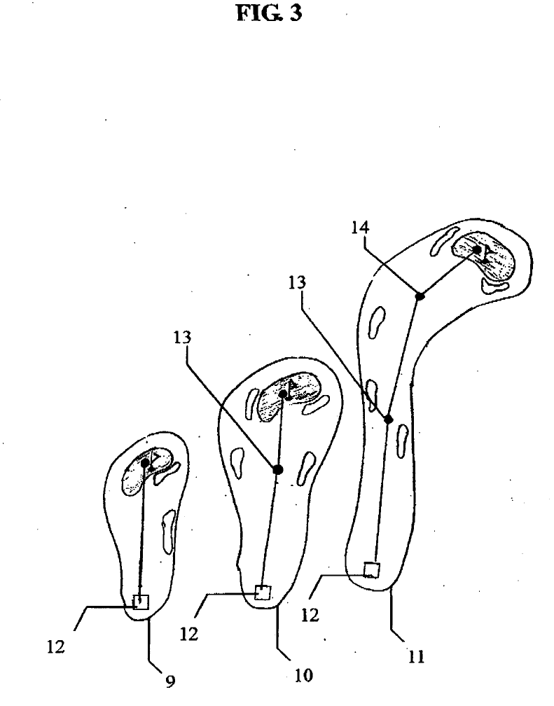

In more detail, still referring to the invention in FIG. 1—When using a cell phone, the golf course GPS coordinates will be included with image and software transfer. This differs from current cell phone GPS apps and devices, in that this invention provides the GPS position from which images are captured, to mark the locations as demonstrated in FIG. 3. While this invention initially uses 2D photos, the coordinates captured can also be used in conjunction with more advanced CAD (computer aided design) mapping software used currently to render golf courses with more detailed graphics which can then be used to provide a top view of the area or entire hole, from which the photo was taken.

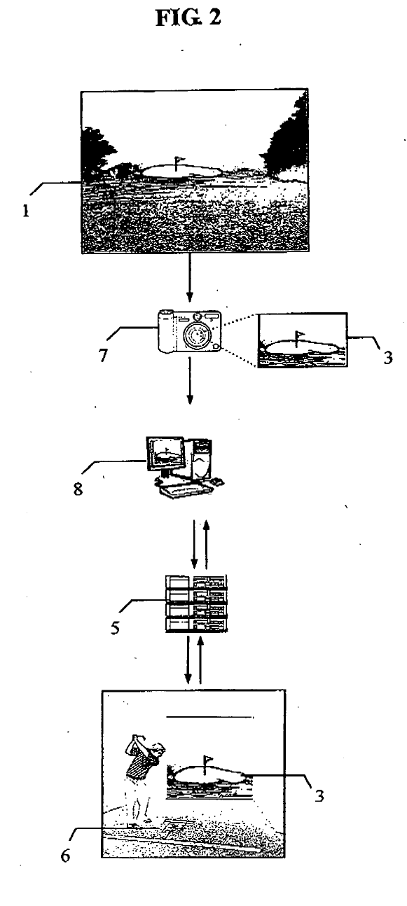

Referring now to the view of invention shown in FIG. 2. This drawing is identical to FIG. 1, with only 2 exceptions. First, a digital or video camera (drawing #7) instead of a cell phone is used to capture the image and secondly; instead of wireless technology, a personal computer (drawing #8) is used to transfer the images to Internet servers (drawing #5) and or golf simulation device (drawing #6).

Now referring to the training component of this invention in FIG. 3 which shows the three general types of holes on golf courses, par 3 (drawing #9), par 4 (drawing #10) and par 5 (drawing #11). Unlike current golf simulator software which has each subsequent shot continue from the place it last landed, this invention differs in that it places the golfer at predetermined locations on each golf hole and guides them through a specific number of swings, to arrive at each green in regulation par. This is commonly referred to as “greens in regulation”. Professional golfers often use this technique as a visualization method on the driving range before competition, switching clubs for each shot to simulate their round in advance.

Drawings #12, #13 and #14 display examples of predetermined locations which are also where photos are taken. The first swing and photo on every hole, is taken from a location referred to as the “Tee” (drawing #12). The second swing and photo (drawing #13) is located where the first shot is intended to land. The third swing and photo are located where the second shot was intended to land. To reach a par 3 green in regulation requires one stroke or swing. To reach a par 4 green in regulation requires 2 strokes and a par 5 requires 3 strokes. A par score for each complete golf hole is achieved by adding 2 putting strokes to the swings for each type of golf hole. In other words, a par 3 consists of 1 swing and 2 putts, a par 4 consists of 2 swings and 2 putts and a par 5 consists of 3 swings and 2 putts.

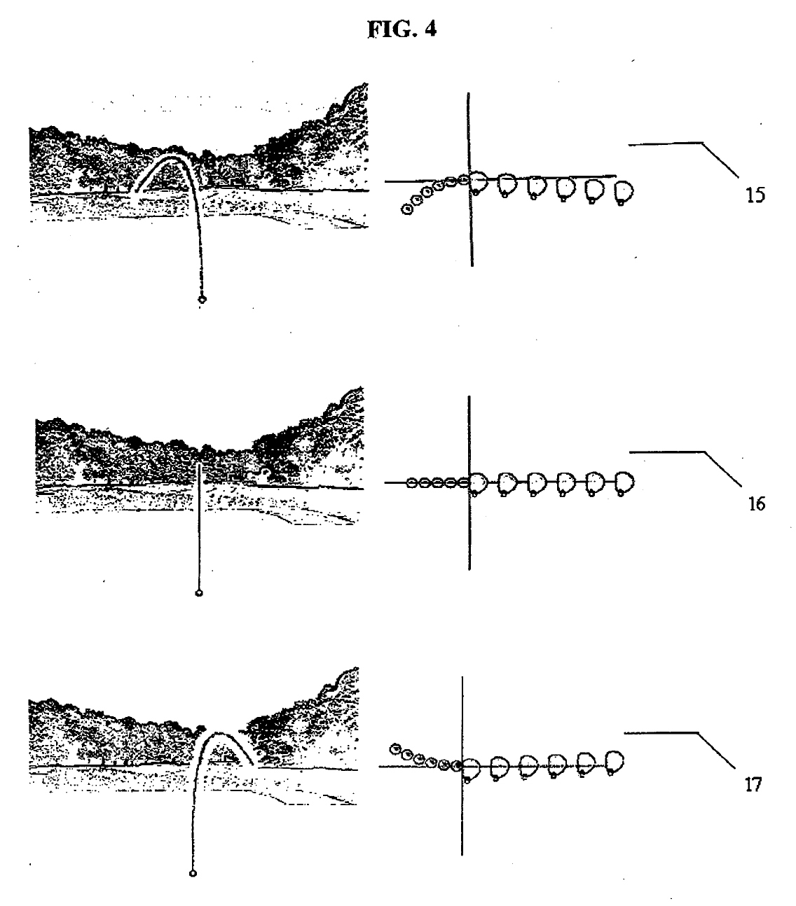

Referring now to FIG. 4. This invention includes a graphical simulation of the club head path and resulting ball flight after each swing. All drawings in the figure assume the golfer is right handed. Drawing #15 shows the club head path and angle as it impacts the ball which would result in a hook shot, next to its corresponding ball flight trail. Drawing #16 shows the club head path and ball trail which would result in a straight shot with corresponding ball flight trail and drawing #17 shows a club head path which would result in a slice, with corresponding ball flight trail.

1. A process that enables anyone to upload local golf course images from a cell phone or digital camera for play on a golf simulation device.

2. A process of claim 1, wherein a cell phone, is utilized to upload images for play on a golf simulation device using text, email or existing photo sharing applications.

3. A process of claim 1, wherein GPS coordinates are gathered with existing software utilizing existing satellite technology to provide relevant geographic data for measurement and enhanced graphic displays.

4. A process of claim 1, wherein a server and computer database manages the storage, sequencing and sharing of course images and names for retrieval through the internet.

5. A process of claim 1, wherein a website is utilized for support of shared images database and players can play the courses or simply view a course online prior to playing it.

6. A process that utilizes existing golf simulation devices, including computer hardware, software and ball flight data to create a graphic overlay on images referenced in claim 1, simulating a golf ball in flight, its trail, trajectory and related data.

7. A training method which embodies a visualization technique commonly used by professional golfers as they imagine and practice their ideal round of golf prior to a professional tournament.

8. A method of claim 7, wherein subsequent shots are taken from a landing area based on the players level of skill and relevant to the beginning tee position.

9. A method of claim 7, wherein the golfer has an option to select a maximum number of shots to be taken per hole.
